(19) United States
(12) Patent Application Publication
(10) Pub. No.: US 2019/0101621 A1
(43) Pub. Date: Apr. 4, 2019

(54) VEHICLE-MOUNTED RADAR DEVICE AND METHOD OF DETECTING AXIAL DEVIATION IN VEHICLE-MOUNTED RADAR DEVICE

(71) Applicant: Panasonic Intellectual Property Management Co., Ltd., Osaka (JP)

(72) Inventors: KAZUHIRO MACHIDA, Chiba (JP); HIDEKUNI YOMO, Kanagawa (JP); JUNJI SATO, Tokyo (JP); AKIHIKO MATSUOKA, Kanagawa (JP); TOMOHIRO MURATA, Kanagawa (JP); TAKAYUKI ABE, Kanagawa (JP); KENTA IWASA, Kanagawa (JP)

(21) Appl. No.: 16/141,666

(22) Filed: Sep. 25, 2018

(30) Foreign Application Priority Data
Oct. 2, 2017 (JP) 2017-192673

(51) Int. Cl. G01S 7/40

(52) U.S. Cl. CPC G01S 7/4026; G01S 2007/4034; G01S 7/40

(57) ABSTRACT

A vehicle-mounted radar device has: a radar transmitting circuit transmitting a radar transmission waves to be reflected at a target; a radar receiving circuit receiving the reflected waves; a radar's axial deviation detecting circuit deciding whether the radar axis of the radar device has a deviation, according to the difference between a first value (distance between the vehicle and the known still object based on a shape of the known still object) and a second value (distance between them at a time when a radar reflected wave having attenuated power of the known still object among the radar reflected waves is received); and an axial deviation notifying circuit making a notification of the axial deviation.

### BACKGROUND

### 1. Technical Field

The present disclosure relates to a vehicle-mounted radar device that detects an axial deviation and a method of detecting an axial deviation in the vehicle-mounted radar device.

### 2. Description of the Related Art

A millimeter-wave radar device attached at the front of a vehicle (the radar device will be simply referred to below as the vehicle-mounted radar as necessary) provides an alarm about a distance between vehicles and/or information used in vehicle speed control as an adaptive cruise control or auto cruise control (ACC) function (see Japanese Unexamined Patent Application Publication No. 2006-275840, for example).

A radar device intended for a standard-sized car is attached in the vicinity of, for example, a bumper, relatively close to the road surface, at the front of the vehicle so that the radar device does not detect structural bodies (such as road signs and guide plates) adequately higher than the height of the vehicle. The radar device sets a narrow radiation width in an elevation angle direction.

A radar device intended for a large-sized special vehicle having a structural body at the front of the vehicle (such as a snow removing vehicle having a snow removing blade or rotational snowplow device) is attached above the driver's seat distant from the road surface to prevent the structural body at the front of the vehicle. As for radar devices attached above the driver's seat, it is being studied to set a radiation width wider than that in a radar device for a normal-sized vehicle in an elevation angle direction so as to assure an adequate detection range and detection distance.

### SUMMARY

With a radar device in which a wide radiation angle is set in an elevation angle direction, a deviation of the center of the radiation width in the elevation angle direction (the deviation will be referred to below as the axial deviation or radar's axial deviation) may affect the detection precision of the radar device. However, adequate countermeasures against this have not been taken.

One non-limiting and exemplary embodiment provides a vehicle-mounted radar device that can easily detect an axial deviation in the vehicle-mounted radar device and can avoid a drop in the detection precision of the vehicle-mounted radar device, and also provides a method of detecting an axial deviation in the vehicle-mounted radar device.

In one general aspect, the techniques disclosed here feature a vehicle-mounted radar device, attached to a vehicle, that has: a radar transmitting circuit that transmits a radar transmission waves; a radar receiving circuit that receives a radar reflected waves created as a result of the radar transmission waves being reflected by a target; a landmark detecting circuit that detects landmark information corresponding to the target from the radar reflected waves; a landmark pursuing circuit that decides whether the target is a known still object by pursuing time-varying changes in a relative position with respect to the vehicle, the relative position being included in the landmark information; a radar's axial deviation detecting circuit that, if the target is a known still object, decides whether a radar axis of the vehicle-mounted radar device has a deviation according to a difference between a first value and a second value, the first value being a first distance between the vehicle and the known still object calculated based on a shape of the known still object, the shape being obtained according to the landmark information, and information about an initial attachment position of the vehicle-mounted radar device, the second value being a second distance at a point of time when a radar reflected wave having attenuated power of the known still object among the radar reflected waves is received; and an axial deviation notifying circuit that makes a notification of a deviation of the radar axis of the vehicle-mounted radar device.

An aspect of the present disclosure contributes to easily detecting an axial deviation in a vehicle-mounted radar device and avoiding a drop in the detection precision of the vehicle-mounted radar device.

It should be noted that these comprehensive or specific aspects may be implemented as a system, a method, an integrated circuit, a computer program, a recording medium, or any selective combination of a system, a device, a method, an integrated circuit, a computer program, and a recording medium.

Additional benefits and advantages of the disclosed embodiments will become apparent from the specification and drawings. The benefits and/or advantages may be individually obtained by the various embodiments and features of the specification and drawings, which need not all be provided in order to obtain one or more of such benefits and/or advantages.

### BRIEF DESCRIPTION OF THE DRAWINGS

FIG. 1 illustrates an example of the structure of a radar device according to an embodiment of the present disclosure;

FIG. 2 illustrates an example of a method in an embodiment of the present disclosure by which the position of a vehicle is predicted;

FIG. 3 illustrates a first example of axial deviation detection in an embodiment of the present disclosure;

FIG. 4 illustrates a second example of axial deviation detection in an embodiment of the present disclosure;

FIG. 5 is a flowchart illustrating an example of processing, according to an embodiment of the present disclosure, that is executed by the radar device;

FIG. 6 is a flowchart illustrating an example of landmark analysis processing in FIG. 5;

FIG. 7 is a flowchart illustrating an example of on-road facility information search processing in FIG. 6; and

FIG. 8 is a flowchart illustrating an example of axial deviation detection processing in FIG. 6.

### DETAILED DESCRIPTION

If an obstruction is present in the vicinity of the vehicle, a radar device used as a vehicle-mounted radar provides landmark information having information about a relative distance to the obstruction with respect to the vehicle, a direction, and a speed to an inter-vehicle distance alarm system or a vehicle speed control system. The inter-vehicle distance alarm system or vehicle speed control system controls the vehicle. For example, the system maintains the distance between the vehicle and the obstruction corresponding to the landmark information according to distance information included in the landmark information, if a collision with the obstruction is predicted, issues an alarm, and reduces the speed of the vehicle (this control is referred to below as collision reducing control) (see Japanese Unexamined Patent Application Publication No. 2006-275840, for example).

A radar device, for example, is being studied that prevents detection of a structural body on the road, such as a traffic sign, that is installed at a position adequately higher than the height of the vehicle and is thereby less likely to collide with the vehicle, as a target eligible for detection (see Japanese Unexamined Patent Application Publication No. 2012-18058, for example).

A vehicle-mounted radar is required to quickly and accurately detect a target that may collide with the vehicle.

In a radar device attached to a standard-sized car, for example, a narrow radiation width is set in an elevation angle direction to reduce the effect of waves reflected from a structural body other than the target and the road surface.

Road signs, viaducts, traffic enforcement cameras, automatic number plate recognition systems, and other structural bodies on high-speed roadways (referred to below as on-road facilities or on-road superstructures at appropriate points) are installed at positions adequately higher than vehicle heights (for example, at heights of at least 4.5 meters) so that they do not impede the traveling of vehicles.

On-road facilities are present at positions adequately higher than the radar axis of a radar device attached to a vehicle. If a narrow radiation width is set in the radar device in an elevation angle direction, therefore, the radar device is less likely to detect an on-road facility as a target. The radar axis of the radar device is at the center of the radiation width (angular range in detection) of the radar device.

However, a radar device for a large-sized special vehicle having a structural body at the front of the vehicle (such as a snow removing vehicle having a snow removing blade or rotational snowplow device) is attached above the driver's seat distant from the road surface to prevent the structural body attached at the front of the vehicle. As for radar devices attached above the driver's seat, it is being studied to set a radiation width wider than that in a radar device for a normal-sized vehicle in an elevation angle direction so as to assure an adequate detection range and detection distance.

When a radiation width wider than that in a radar device for a normal-sized vehicle is set in a radar device in an elevation angle direction, precision with which the radar device detects a target (for example, precision of a distance to the target) is lowered due to the effect of the deviation of the radar axis.

In a known method of reducing this effect of the deviation of the radar axis, the directivity of antenna is controlled, However, it is difficult to control the directivity of antenna in vehicle-mounted radars for which downsizing and low costs are demanded. Therefore, there is a demand for easily detecting the deviation of the radar axis of the radar device.

In view of this, one non-limiting embodiment in the present disclosure contributes to providing a radar device that can easily detect the deviation of a radar axis in a radar device and can avoid a drop in the detection precision of the radar device and to providing a method of detecting an axial deviation.

An embodiment of the present disclosure will be described below in detail with reference to the drawings. The embodiment described below is just an example. The present disclosure is not limited by the embodiment below.

### EMBODIMENT

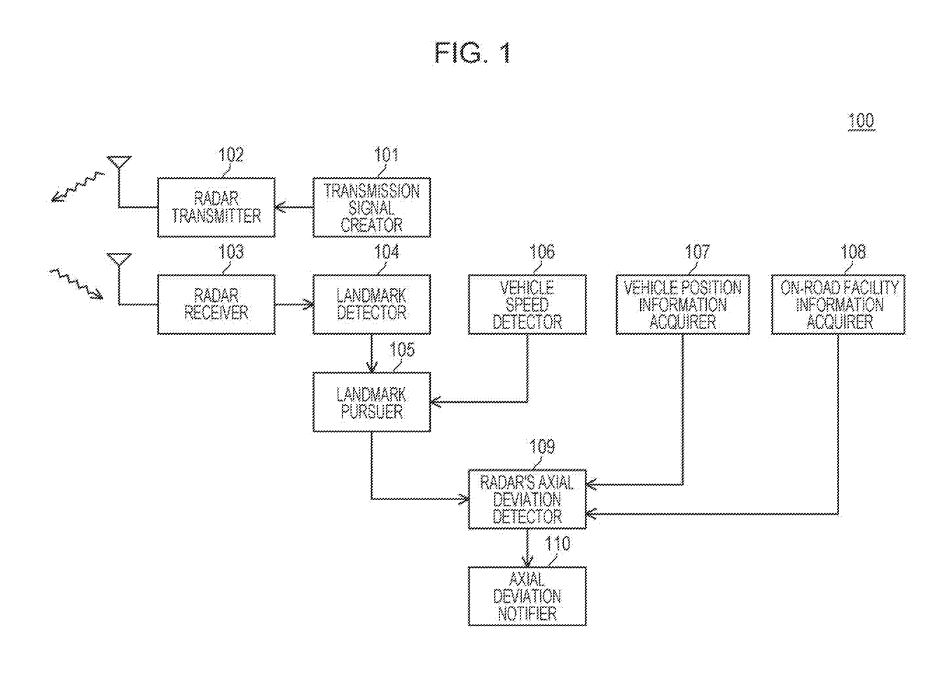

FIG. 1 illustrates an example of the structure of a radar device 100 according to this embodiment. The radar device 100 in FIG. 1 is attached above the driver's seat of a large-sized special vehicle (such as a snow removing vehicle) that is higher than normal-sized vehicles and has a structural body at the front of the vehicle. The radar device 100 detects a target present in front of the vehicle. The target is an object eligible for being detected by the radar device 100. The target is a still object or moving object.

The radar device 100 has a transmission signal creator 101, a radar transmitter 102, a radar receiver 103, a landmark detector 104, a landmark pursuer 105, a vehicle speed detector 106, a vehicle position information acquirer 107, an on-road facility information acquirer 108, a radar's axial deviation detector 109, and an axial deviation notifier 110.

The transmission signal creator 101 creates a radar transmission wave to be transmitted from the radar transmitter 102. There is no limitation on the method of creating the radar transmission wave. The radar transmission wave only needs to be a transmission wave in a frequency modulated continuous wave (FMCW) method, a pulse compression method, or another method of detecting a target according to the reception electric power of a reflected wave,

The radar transmitter 102, which has a transmission antenna, performs transmission processing (for example, frequency conversion and amplification) on the radar transmission wave created by the transmission signal creator 101, and transmits the radar transmission wave that has undergone transmission processing. The radar transmitter 102 transmits 20 frames of radar transmission waves per second.

The radar receiver 103, which has a reception antenna, receives radar reflected waves created as a result of radar transmission waves being reflected by the target one frame at a time. The radar receiver 103 performs reception processing (for example, frequency conversion and amplification) on each received reflected waves and outputs information about the radar reflected wave that has undergone reception processing to the landmark detector 104.

The landmark detector 104 acquires radar reflected waves in succession one frame at a time from the radar receiver 103, and detects a landmark related to each object one frame at a time from information (for example, electric power profile information) on the acquired radar reflected waves. The landmark indicates information (marking) used to recognize and/or identify the target. Each detected landmark is associated with at least positional information about a relative position with respect to the radar device 100 and information about an average electric power value. A combination of positional information about a relative position with respect to the radar device 100 and information about an average electric power value for each landmark will be referred to below as landmark information. Although there is no limitations on the method of detecting a landmark, examples of the method include a labeling method and clustering method.

The landmark pursuer 105 acquires one-frame landmark information from the landmark detector 104 and manages landmark information in a plurality of frames in time-series form. The landmark pursuer 105 calculates the amount of change in the relative position and the amount of change in the average electric value for each landmark. The landmark pursuer 105 pursues time-varying changes in the relative position and decides whether the target corresponding to the landmark is a still object. According to the travel speed (vehicle speed) of the vehicle, the speed being obtained from the vehicle speed detector 106, and to the amount of changes in the relative position of the landmark, for example, the landmark pursuer 105 decides that if the absolute position of a target corresponding to a landmark remains unchanged, the target is a still object.

The vehicle speed detector 106 detects the vehicle speed according to the number of rotations of a driving wheel of the vehicle and/or an engine output. Although not illustrated, the vehicle speed detector 106 may use radar reflected waves to detect the vehicle speed.

The vehicle position information acquirer 107 acquires information about the absolute position of the vehicle by, for example, receiving signals from Global Positioning System (GPS) satellites.

The on-road facility information acquirer 108 acquires information about on-road facilities installed on roads such as, for example, road signs and guide plates (the information will be referred to below as on-road facility information) from a database possessed by a road management company. On-on-road facility information includes the positions of on-road facilities and their shapes (for example, heights from the road surface and angles at which the on-road facilities are installed with respect to the road surface).

The radar's axial deviation detector 109 identifies the absolute position of the still object, which has been determined to be still by the landmark pursuer 105 according to the landmark information, according to the absolute position of the vehicle, the absolute position being obtained from the vehicle position information acquirer 107, and to the relative position of the still object. The radar's axial deviation detector 109 acquires, from the on-road facility information acquirer 108, on-road facility information corresponding to the absolute position of the still object, which has been determined to be still by the landmark pursuer 105 according to the landmark information. The radar's axial deviation detector 109 then calculates a predicted value of the distance between the vehicle and the on-road facility, according to the shape of the on-road facility, the shape being obtained according to the landmark information, and to information about the initially installed position of the radar device 100. The predicted value is the distance between the vehicle and the on-road facility at the point in time at which it is predicted that electric power in the electric power profile of the landmark corresponding to the on-road facility will be reduced when there is no radar's axial deviation.

The radar's axial deviation detector 109 pursues changes in electric power in the electric power profile of the landmark corresponding to the on-road facility, and calculates the actual value of the distance between the road and the on-road facility at the point in time at which the electric power has been actually reduced.

The radar's axial deviation detector 109 then decides whether the radar device 100 has an axial deviation according to the difference between the predicted value and the actual value.

Specific examples of the method of calculating the predicted value and the method of deciding whether there is an axial deviation will be described later.

The axial deviation notifier 110 notifies the driver of the vehicle whether the radar's axial deviation detector 109 has detected an axial deviation as text information and/or voice information. The axial deviation notifier 110 may store the presence or absence of an axial deviation as log information. Alternatively, the axial deviation notifier 110 may notify the management company or maintenance company of the vehicle whether the vehicle has an axial deviation.

Next, an example of the method of obtaining a predicted value in the radar's axial deviation detector 109 will be described.

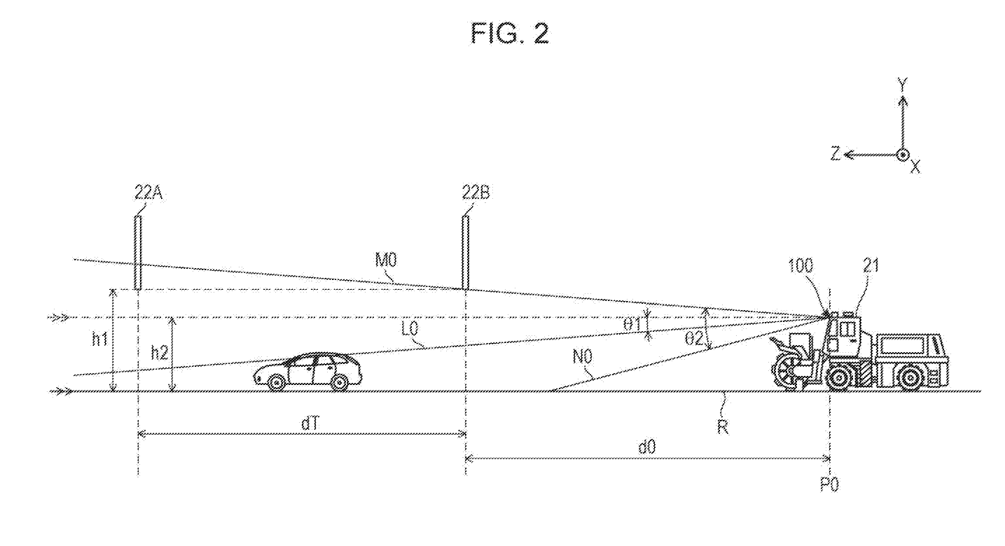

FIG. 2 illustrates an example of a method of obtaining a predicted value in this embodiment. In FIG. 2, a road R extending in the Z-axis direction on an X-Z plane, a vehicle 21 traveling on the road R in the position direction of the Z axis, and an on-road facility 22 (indicated by 22A and 22B), which is a still object installed on the road R, are illustrated.

The vehicle 21 is, for example, a snow removing vehicle. The vehicle 21 is higher than normal-sized vehicles, and has a structural body at the front, the structural body removing snow on the road. Therefore, the radar device 100 is attached above the driver's seat of the vehicle 21. The height of the position at which the radar device 100 is attached (the length from the surface of the road R to the position at which the radar device 100 is attached) is denoted h2.

The on-road facility 22 is a guide plate or road sign that provides information to the driver of a vehicle traveling on the road R. The on-road facility 22 is supported by, for example, a pole (not illustrated) extending from a side strip of the road R in the positive direction of the Y axis, and is shaped like a plane extending along an X-Y plane. The height of the on-road facility 22 (that is, the length from the surface of the road R to the bottom edge of the on-road facility 22) is denoted h1.

For convenience of illustration, in FIG. 2, the position of the vehicle 21 traveling in the positive direction of the Z axis is fixed to P0 and the position of the on-road facility 22 installed on the road R is moved in the negative direction of the Z axis. In FIG. 2, as an example, an on-road facility 22A at time t and an on-road facility 22B at time t+T, which is behind time t are illustrated as one on-road facility 22 for the vehicle 21 fixed at P0. The distance dT between the on-road facility 22A and the on-road facility 22B corresponds to the distance over which the vehicle 21 has travelled in time T.

A radar axis L0 extending from the radar device 100 is a radar axis in the case of no axial deviation. An angle formed by the radar axis L0 and a straight line parallel to the road R is denoted θ1. A straight line M0 and a straight line N0, which extend from the radar device 100 with the radar axis L0 intervening between them, are respectively the upper boundary and lower boundary of an angular range (radiation width) of the radar device 100 in the elevation angle direction with respect to the radar axis L0. The angular range of the radar device 100 in the elevation angle direction is an angle θ2 formed between the straight line M0 and the straight line N0.

The angle θ1, angle θ2, and height h2 are stipulated when the radar device 100 is attached. The radar's axial deviation detector 109 in the radar device 100 holds information about the angle θ1, angle θ2, and height h2 in advance as information about the initially installed position of the radar device 100.

The radar's axial deviation detector 109 acquires on-road facility information about the on-road facility 22 from the on-road facility information acquirer 108. The on-road facility information is, for example, about the position of the on-road facility 22 and information about the height h1 of the on-road facility 22.

If the radar axis has no deviation, the radar's axial deviation detector 109 obtains a predicted value d0 of the distance between the vehicle 21 and the on-road facility 22 at the position in time at which the electric power of the landmark corresponding to the on-road facility 22 is reduced. The position in time at which the electric power of the landmark corresponding to the on-road facility 22 is reduced is, for example, the position in time at which it is predicted that the on-road facility 22 deviates from the angular range of the radar device 100 like the on-road facility 22B in FIG. 2 (that is, the on-road facility 22 is at a position higher than the straight line M0) and radar transmission waves are not reflected by the on-road facility 22 (or radar transmission waves are not received from the on-road facility 22).

The predicted valued d0 is calculated by using the height h1, height h2, angle θ1, and angle θ2, according to equation (1).

$$d 0 = \frac{h 1 - h 2}{tan ( \frac{θ2}{2} - θ 1 )} \qquad ( 1 )$$

The radar's axial deviation detector 109 obtains the predicted value d0 in advance by using the prediction method described above.

The radar's axial deviation detector 109 monitors the electric power in the landmark information obtained in succession from the landmark pursuer 105 in correspondence to the on-road facility 22. The radar's axial deviation detector 109 takes the distance between the vehicle 21 and the relevant on-road facility 22 at the point in time at which electric power in the electric power profile of the landmark corresponding to the on-road facility 22 has been actually reduced as the actual value calculated by using a radar reflected wave. The radar's axial deviation detector 109 then decides whether there is an axial deviation, according to the difference between the predicted value and the actual value.

Next, a specific example of the method by which the radar's axial deviation detector 109 detects a radar's axial deviation will be described.

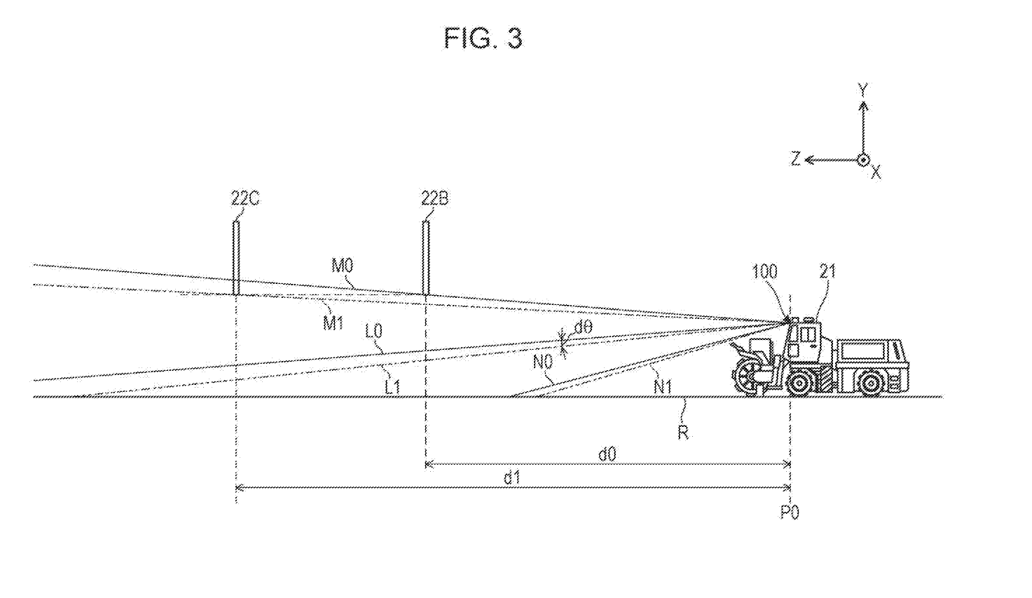

FIG. 3 illustrates a first example of axial deviation detection in this embodiment. In FIG. 3, the vehicle 21 having the radar device 100, the radar axis L0 in the case of no axial deviation, and the upper boundary M0 and lower boundary N0 of the angular range of the radar device 100 in the elevation angle direction, which are all illustrated in FIG. 2, are illustrated.

In FIG. 3, a radar axis L1 different from the radar axis L0 and the upper boundary M1 and lower boundary N1 of the angular range of the radar device 100 in the elevation angle direction with respect to the radar axis L1 are also illustrated. The radar axis L1 has a downward axial deviation with respect to the radar axis L0. The boundaries M1 and N1 are deviated downward from the boundaries M0 and N0, respectively, in correspondence to the axial deviation.

Since a deviation occurs in the angular range of the radar device 100 in the elevation angle direction in correspondence to the axial deviation, a deviation also occurs at the point in time at which the electric power in the electric power profile of the landmark corresponding to the on-road facility 22 is reduced. In FIG. 3, for example, the on-road facility 22 deviates from the angular range between the boundary M1 and the boundary N1. Instead, a road facility 22C is indicated at the point in time at which a radar transmission wave no longer has been reflected by the on-road facility 22.

As described above, the radar's axial deviation detector 109 monitors the electric power in the landmark information obtained in succession from the landmark pursuer 105 in correspondence to the on-road facility 22. The radar's axial deviation detector 109 then calculates an actual value dl of the distance between the vehicle 21 and the on-road facility 22 (specifically, the on-road facility 220) at the point in time at which electric power in the electric power profile of the landmark corresponding to the on-road facility 22 has been actually reduced, that is, at the point in time at which, in FIG. 3, the on-road facility 22 has reached the position of the on-road facility 22C.

For example, the radar's axial deviation detector 109 may use time at which a radar transmission wave was transmitted and time at which a radar reflected wave was received to calculate, as the actual value d1, the distance to the landmark at which electric power has been reduced. Alternatively, the radar's axial deviation detector 109 may acquire, from the vehicle position information acquirer 107, the absolute position of the vehicle 21 at the point in time at which the electric power of the landmark has been actually reduced, and may calculate the difference between the absolute position of the vehicle 21 and the absolute position of the road facility 22 corresponding to the landmark as the actual value d1.

In FIG. 3, the actual value d1 is larger than the predicted value d0 by a predetermined value or more. In this case, the radar's axial deviation detector 109 decides that the axis has a downward deviation.

The radar's axial deviation detector 109 may infer the magnitude of the axial deviation from the difference between the actual value dl and the predicted value d0.

For example, an angle d0 in FIG. 3, which is the magnitude of the axial deviation between the radar axis L0 and the radar axis L1, is calculated according to equation (2).

$$d θ = ( \frac{θ 2}{2} - θ1 ) - arctan ( \frac{h 1 - h 2}{d 1} ) \qquad ( 2 )$$

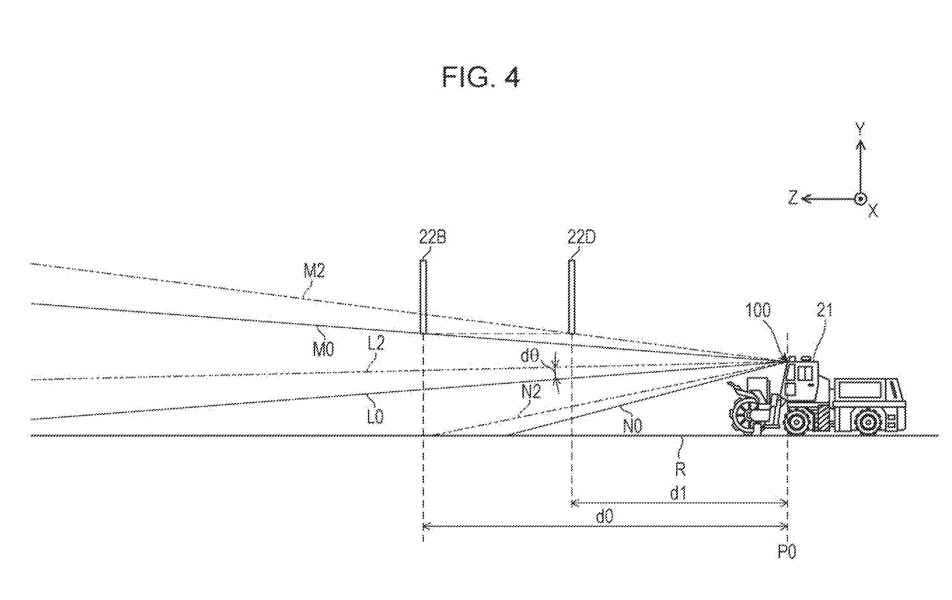

FIG. 4 illustrates a second example of axial deviation detection in this embodiment. In FIG. 4, the vehicle 21 having the radar device 100, the radar axis L0 in the case of no axial deviation, and the upper boundary M0 and lower boundary N0 of the angular range of the radar device 100 in the elevation angle direction, which are all illustrated in FIG. 2, are illustrated.

In FIG. 4, a radar axis L2 different from the radar axis L0 and the upper boundary M2 and lower boundary N2 of the angular range of the radar device 100 in the elevation angle direction with respect to the radar axis L2 are also illustrated. The radar axis L2 has an upward axial deviation with respect to the radar axis L0, The boundaries M2 and N2 are deviated upward from the boundaries M0 and N0, respectively, in correspondence to the axial deviation.

Since a deviation occurs in the angular range of the radar device 100 in the elevation angle direction in correspondence to the axial deviation, a deviation also occurs at the point in time at which the electric power of the landmark corresponding to the on-road facility 22 is reduced. In FIG. 4, for example, the on-road facility 22 deviates from the angular range between the boundary M2 and the boundary N2. Instead, a road facility 22D is indicated at the point in time at which a radar transmission wave no longer has been reflected by the on-road facility 22.

As described above, the radar's axial deviation detector 109 monitors the electric power in the landmark information obtained in succession from the landmark pursuer 105 in correspondence to the on-road facility 22. The radar's axial deviation detector 109 then calculates the actual value d1 of the distance between the vehicle 21 and the relevant on-road facility 22 (specifically, the on-road facility 22D) at the point in time at which electric power of the landmark corresponding to the on-road facility 22 has been actually reduced, that is, at the point in time at which, in FIG. 4, the on-road facility 22 has reached the position of the on-road facility 22D by, for example, using time at which a radar transmission wave was transmitted and time at which a radar reflected wave was received.

In FIG. 4, the actual value d1 is smaller than the predicted value d0 by a predetermined value or more. In this case, the radar's axial deviation detector 109 decides that the axis has an upward deviation.

The radar's axial deviation detector 109 may infer the magnitude of the axial deviation from the difference between the actual value d1 and the predicted value d0 by using equation (2) described above.

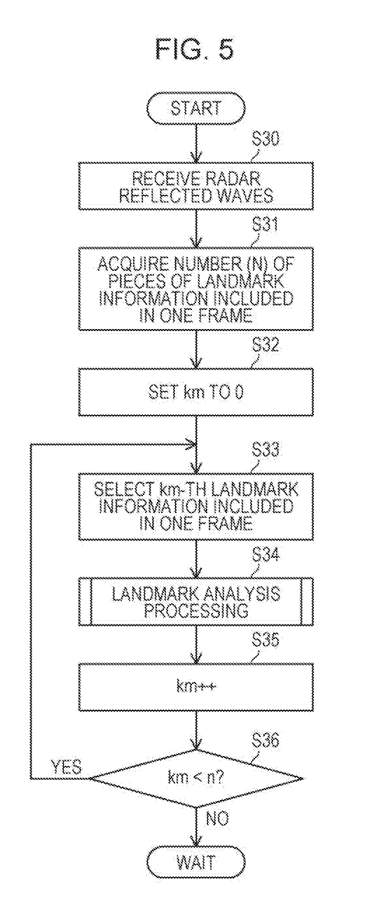

Next, the flow of processing according to this embodiment will be described, the processing being executed by the radar device 100. FIG. 5 is a flowchart illustrating an example of processing, according to this embodiment, that is executed by the radar device 100. The flowchart in FIG. 5 illustrates a flow executed during the traveling of the vehicle 21.

In step S30, the radar receiver 103 receives radar reflected waves created as a result of target-caused reflection of radar transmission waves transmitted from the radar transmitter 102.

In step S31, the landmark detector 104 detects landmarks included in one frame and acquires the number (n) of pieces of landmark information included in one frame (n is an integer equal to or larger than 1).

In step S32, the landmark pursuer 105 sets the index km of a landmark to be pursued to 0 as initialization processing.

In step S33, the landmark pursuer 105 selects km-th landmark information included in one frame.

In step S34, the landmark pursuer 105 performs landmark analysis processing, which will be described later, on the km-th landmark information.

In step S35, the landmark pursuer 105 increments the index km by one.

In step S36, the landmark pursuer 105 decides whether the index km is smaller than n.

If the index km is smaller than n (the result in step S36 is Yes), that is, analysis has not been terminated for all the n landmarks, the landmark pursuer 105 returns to processing in step S33, where the landmark pursuer 105 performs landmark analysis processing on a next landmark.

If the index km is not smaller than n (the result in step S36 is No), that is, analysis has been terminated for all the n landmarks, the processing flow for the radar reflected waves is terminated for one frame. The radar receiver 103 waits to receive radar reflected waves in a next frame.

Next, landmark analysis processing in step S34 in FIG. 5 will be described.

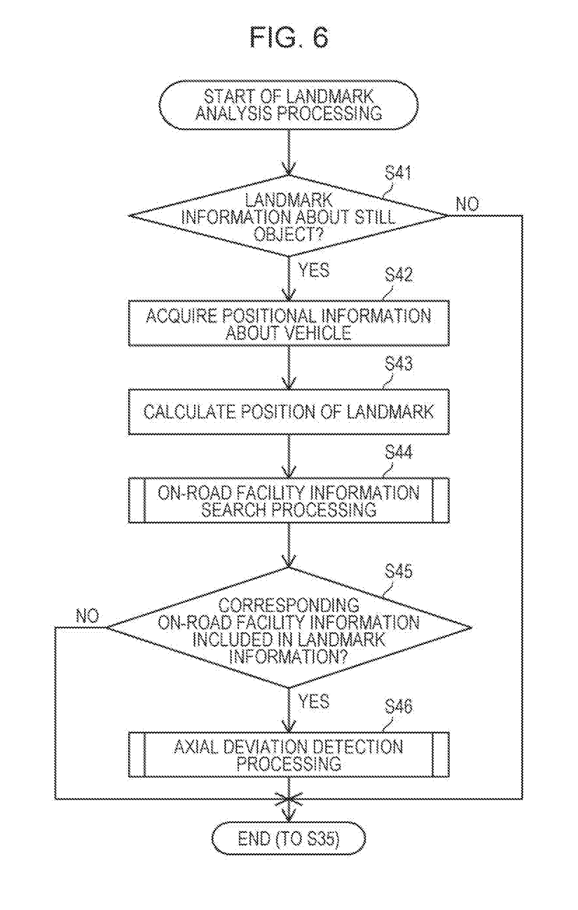

FIG. 6 is a flowchart illustrating an example of landmark analysis processing in FIG. 5.

In step S41, the landmark pursuer 105 decides whether the selected landmark information (that is, the km-th landmark information) is landmark information about a landmark corresponding to a still object. For example, the landmark pursuer 105 calculates the amount of change in the position of the km-th landmark from positional information in the km-th landmark information in at least one previous frame and positional information in the km-th landmark information in the current frame. According to the amount of change and the vehicle speed, the landmark pursuer 105 decides whether the landmark information is about a landmark corresponding to a still object.

If the selected landmark information is not about a landmark corresponding to a still object (the result in step S41 is No), landmark analysis processing on the selected landmark information is terminated and the flow moves to step S35 in FIG. 5.

If the selected landmark information is about a landmark corresponding to a still object (the result in step S41 is Yes), the radar's axial deviation detector 109 acquires positional information indicating the absolute position of the vehicle 21 from the vehicle position information acquirer 107 in step S42.

In step S43, the radar's axial deviation detector 109 calculates the absolute position of the landmark from the absolute position of the vehicle 21 and the relative position of the landmark with respect to the vehicle 21 (specifically, the radar device 100).

In step S44, the radar's axial deviation detector 109 performs on-road facility information search processing, which will be described later, according to the calculated absolute position of the landmark.

In step S45, the radar's axial deviation detector 109 decides whether there is facility information corresponding to the landmark information. For example, the radar's axial deviation detector 109 decides whether there is on-road facility information indicating an on-road facility present at the absolute position of the landmark, according to the absolute position of the landmark and the position of the road facility included in the searched on-road facility information.

If there is no facility information corresponding to the landmark information (the result in step S45 is No), for example, if the landmark corresponds to a still object different from a road facility, landmark analysis processing on the selected landmark information is terminated and the flow moves to step S35 in FIG. 5.

If there is facility information corresponding to the landmark information (the result in step S45 is Yes), the radar's axial deviation detector 109 executes axial deviation detection processing, which will be described later, in step S46, terminating the landmark analysis processing on the selected landmark information. Then, the flow moves to step S35 in FIG. 5.

Next, on-road facility information search processing in step S44 in FIG. 6 will be described.

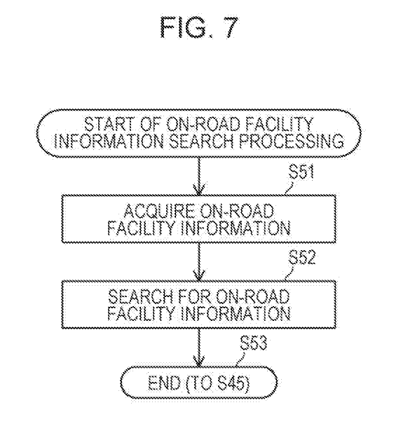

FIG. 7 is a flowchart illustrating an example of on-road facility information search processing in FIG. 6.

In step S51, the radar's axial deviation detector 109 acquires, from the on-road facility information acquirer 108, information about an on-road facility present in the vicinity of the absolute position of the landmark.

In step S52, the radar's axial deviation detector 109 searches for on-road facility information about an on-road facility present within a predetermined distance from the absolute position of the landmark, terminating the on-road facility information search processing in FIG. 7. Then, the flow moves to step S45 in FIG. 6.

Next, axial deviation detection processing in step S46 in FIG. 6 will be described.

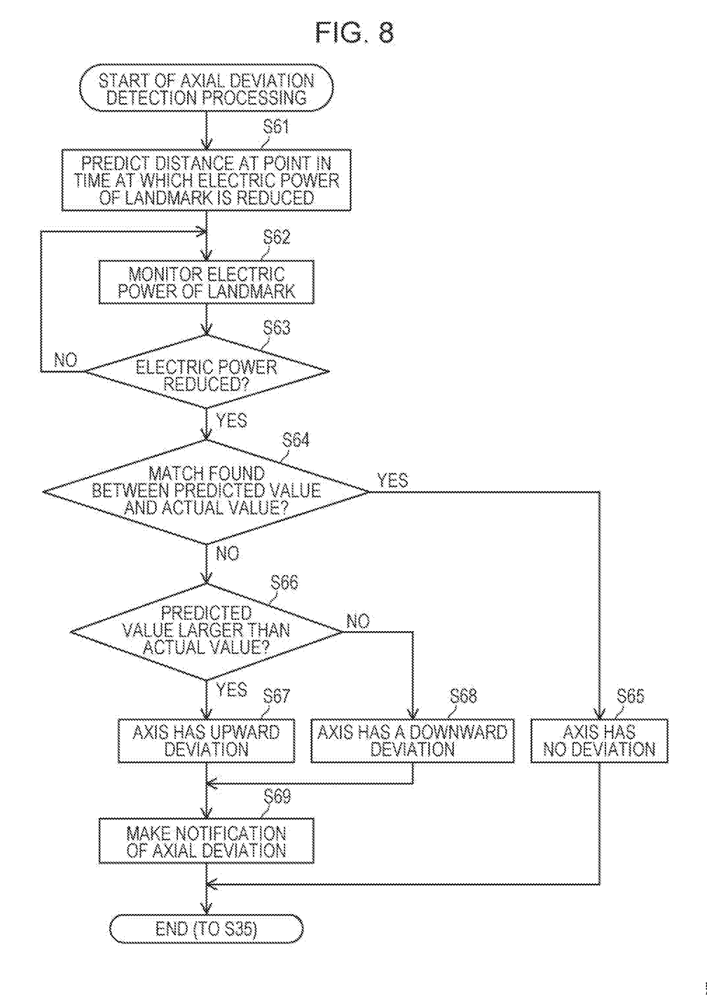

FIG. 8 is a flowchart illustrating an example of axial deviation detection processing in FIG. 6.

In step S61, the radar's axial deviation detector 109 obtains a predicted value of the distance between the vehicle 21 and an on-road facility at the point in time at which electric power in the electric power profile of the landmark corresponding to the on-road facility is predicted to be reduced, according to the on-road facility information corresponding to the landmark information.

In step S62, the radar's axial deviation detector 109 pursues and monitors electric power in the electric power profile of the target landmark in at least one frame previous to the current frame.

In step S63, the radar's axial deviation detector 109 decides whether electric power in the electric power profile of the target landmark has been reduced.

If electric power in the electric power profile of the target landmark has not been reduced (the result in step S63 is No), the flow returns to step S62, where the radar's axial deviation detector 109 continues to monitor electric power.

If electric power in the electric power profile of the target landmark has been reduced (the result in step S63 is Yes), the radar's axial deviation detector 109 calculates an actual value of the distance between the vehicle 21 and the on-road facility at the point in time at which electric power in the electric power profile of the landmark has been actually reduced, and decides in step S64 whether there is a match between the calculated actual value and the predicted value obtained in step S61.

If, for example, the difference between the predicted value and the actual value is smaller than a threshold, the radar's axial deviation detector 109 decides that there is a match between the predicted value and the actual value.

If there is a match between the predicted value and the actual value (the result in step S64 is Yes), the radar's axial deviation detector 109 decides in step S65 that the radar axis has no deviation, terminating the axial deviation detection processing in FIG. 8. Then, the flow moves to step S35 in FIG. 5.

If there is no match between the predicted value and the actual value (the result in step S64 is No), for example, if the difference between the predicted value and the actual value is equal to or larger than a predetermined value, the radar's axial deviation detector 109 decides whether the predicted value is larger than the actual value in step S66.

If the predicted value is larger than the actual value (the result in step S66 is Yes), the radar's axial deviation detector 109 decides in step S67 that the radar axis has an upward deviation. Then, the flow moves to step S69.

If the predicted value is smaller than the actual value (the result in step S66 is No), the radar's axial deviation detector 109 decides in step S68 that the radar axis has a downward deviation. Then, the flow moves to step S69.

In step S69, the axial deviation notifier 110 makes a notification of a deviation of the radar axis, terminating the axial deviation detection processing in FIG. 8. Then, the flow moves to step S35 in FIG. 5.

The radar's axial deviation detector 109 may not decide whether the direction of the axial deviation is upward or downward. In this case, if the result in step S64 in FIG. 8 is No, the flow may skip steps S66 to S68 and may move to step S69.

If an axial deviation is detected, the radar device 100 may stop the processing in FIGS. 5 to 8 without detecting an axial deviation again. In this case, after the axial deviation notifier 110 has made a notification of a deviation of the radar axis in step S69, for example, the processing may be terminated without the flow moving to step S35 in FIG. 5.

However, if an axial deviation is detected, when the radar device 100 detects an axial deviation again, precision in the detection of an axial deviation can be improved. The difference between the predicted value and the actual value may temporarily become large due to, for example, the effect of the shape of the road surface or the shape of an on-road facility. When the detection of an axial deviation is performed several times, this type of temporary effect can be avoided.

As described above, the radar device 100 according to this embodiment calculates a predicated value (first value) of the distance between an on-road facility and the vehicle when there is no axial deviation, and decides whether there is an axial deviation according to the difference between the predicted value (first value) and an actual value (second value) of the distance between the on-road facility and the vehicle, the actual value being calculated by monitoring electric power in the electric power profile of a landmark. This enables the radar device 100 to easily detect an axial deviation during the traveling of the vehicle. Therefore, it is possible to determine whether the maintenance of the radar device 100 including the adjustment of its attachment position is needed and thereby to avoid a drop in precision with which the radar device 100 detects an axial deviation, for example.

Although, in the embodiment described above, an on-road facility has been taken as an example of a still object, the present disclosure is not limited to this. If, for example, a still object is a known still object that is temporarily included in the angular range (radiation width) of the radar device 100 in the elevation angle direction and for which information about the height of the still object is known or can be acquired, the still object is not limited to an on-road facility.

Although, in the embodiment described above, an example has been described in which a vehicle to which the radar device 100 is attached is a large-sized special vehicle, the present disclosure is not limited to this. If the angular range (radiation width) set in the radar device 100 in the elevation angle direction is relatively wide and the radar device 100 is attached to an upper portion of the vehicle, there is no limitation on the form of the vehicle.

Although, in the embodiment described above, an example has been described in which a notification of an axial deviation is made, the present disclosure is not limited to this. If, for example, the radar device 100 makes a decision about an obstruction corresponding to a landmark and calculates a distance to the obstruction relative to the vehicle, an orientation, and a speed, the radar device 100 may correct the distance, orientation, and speed according to the presence or absence of an axial deviation and the amount of axial deviation if any.

The present disclosure can be implemented by software, hardware, or software that works in cooperation with hardware.

Each functional block used in the description of the above embodiment can be partly or entirely implemented by an LSI circuit, which is a type of integrated circuit, and each process described in the above embodiment may be partly or entirely controlled by a single LSI circuit or a combination of LSI circuits. Each LSI circuit may be formed as an individual chip, or a single chip may be formed so as to include part or all of the functional blocks. The LSI circuit may include a data input and a data output. The LSI circuit may be referred to as an IC, a system LSI circuit, a super LSI circuit, or an ultra LSI circuit depending on a difference in the degree of integration.

The technique of implementing an integrated circuit is not limited to an LSI circuit and may be implemented by using a special circuit, a general-purpose processor, or a special processor. Alternatively, a field programmable gate array (FPGA) that can be programmed after the manufacture of the LSI circuit or a reconfigurable processor in which the connections and the settings of circuit cells in the LSI circuit can be reconfigured may be used.

The present disclosure may be implemented as digital processing or analog processing. Furthermore, if a technology of circuit integration appears as a substitution for LSI circuits due to advanced semiconductor technology or another technology derived from semiconductor technology, the technology may be of course used to integrate functional blocks. Application of bio-technology may be possible.

So far, an embodiment has been described with reference to the drawings. However, it will be appreciated that the present disclosure is not limited to the embodiment. It is apparent that persons having ordinary skill in the art can devise various examples of variations and various examples of corrections, without departing from the intended scope of the claims of the present disclosure. It will be understood that these examples are of course included in the technical range of the present disclosure. Various constituent elements in the above embodiment may be arbitrarily combined, without departing from the intended scope of the present disclosure.

In the above description, the expressions “-er” and “-or” are used to represent constituent elements. In stead of these expressions, other words such as “circuitry”, “device”, “unit”, and “module” may be used to represent constituent elements.

### Conclusion in the Present Disclosure

A vehicle-mounted radar device, in the present disclosure, that is attached to a vehicle has: a radar transmitting circuit that transmits a radar transmission waves; a radar receiving circuit that receives a radar reflected waves created as a result of the radar transmission waves being reflected by a target; a landmark detecting circuit that detects landmark information corresponding to the target from the radar reflected waves; a landmark pursuing circuit that decides whether the target is a known still object by pursuing time-varying changes in a relative position with respect to the vehicle, the relative position being included in the landmark information; a radar's axial deviation detecting circuit that, if the target is a known still object, decides whether a radar axis of the vehicle-mounted radar device has a deviation according to a difference between a first value and a second value, the first value being a first distance between the vehicle and the known still object calculated based on a shape of the known still object, the shape being obtained according to the landmark information, and information about an initial attachment position of the vehicle-mounted radar device, the second value being a second distance at a point of time when a radar reflected wave having attenuated power of the known still object among the radar reflected waves is received; and an axial deviation notifying circuit that makes a notification of a deviation of the radar axis of the vehicle-mounted radar device.

With the vehicle-mounted radar device in the present disclosure, if the first value is larger than the second value by a predetermined value or more, the radar's axial deviation detecting circuit decides that the radar axis has a downward deviation; if the second value is larger than the first value by a predetermined value or more, the radar's axial deviation detecting circuit decides that the radar axis has an upward deviation.

With the vehicle-mounted radar device in the present disclosure, the known still object is an on-road facility installed on a road on which the vehicle travels. The vehicle-mounted radar device has an information acquiring circuit that acquires information about the shape of the known still object from a database related to the on-road facility.

With the vehicle-mounted radar device in the present disclosure, to decide whether the target is a known still object, the landmark pursuing circuit acquires the traveling speed of the vehicle and compares the traveling speed with the time-varying changes in the relative position.

With the vehicle-mounted radar device in the present disclosure, the information about the initial attachment position of the vehicle-mounted radar device is information at the time of attachment of the vehicle-mounted radar device, the information including a height from the road and the angle of the radar axis with respect to the road.

A method, in the present disclosure, of detecting an axial deviation in a vehicle-mounted radar device includes: transmitting a radar transmission waves from a vehicle-mounted radar device attached to a vehicle; receiving a radar reflected waves created as a result of the radar transmission waves being reflected by a target; detecting landmark information corresponding to the target from the radar reflected waves; deciding whether the target is a known still object by pursuing time-varying changes in a relative position with respect to the vehicle, the relative position being included in the landmark information; deciding, if the target is a known still object, whether a radar axis of the vehicle-mounted radar device has a deviation according to a difference between a first value and a second value, the first value being a first distance between the vehicle and the still object calculated based on a shape of the known still object, the shape being obtained according to the landmark information, and information about an initial attachment position of the vehicle-mounted radar device, the second value being a second distance at a point of time when a radar reflected wave having attenuated power of the known still object among the radar reflected waves is received; and making a notification of a deviation of the radar axis of the vehicle-mounted radar device.

The present disclosure is useful or a vehicle-mounted radar.

What is claimed is:

1. A vehicle-mounted radar device that is attached to a vehicle, the device comprising:
a radar transmitting circuit that transmits radar transmission waves;
a radar receiving circuit that receives radar reflected waves created as a result of the radar transmission waves being reflected by a target;
a landmark detecting circuit that detects landmark information corresponding to the target from the radar reflected waves;
a landmark pursuing circuit that decides whether the target is a known still object by pursuing a time-varying change in a relative position with respect to the vehicle, the relative position being included in the landmark information;
a radar's axial deviation detecting circuit that, if the target is a known still object, decides whether a radar axis of the vehicle-mounted radar device has a deviation according to a difference between a first value and a second value, the first value being a first distance between the vehicle and the known still object calculated based on a shape of the known still object, the shape being obtained according to the landmark information, and information about an initial attachment position of the vehicle-mounted radar device, the second value being a second distance at a point of time when a radar reflected wave having attenuated power of the known still object among the radar reflected waves is received; and
an axial deviation notifying circuit that makes a notification of a deviation of the radar axis of the vehicle-mounted radar device.

2. The vehicle-mounted radar device according to claim 1, wherein:
if the first value is larger than the second value by a determined value or more, the radar's axial deviation detecting circuit decides that the radar axis has a downward deviation; and
if the second value is larger than the first value by a determined value or more, the radar's axial deviation detecting circuit decides that the radar axis has an upward deviation.

3. The vehicle-mounted radar device according to claim 1, wherein:
the known still object is an on-road facility installed on a road on which the vehicle travels; and
the vehicle-mounted radar device further comprises an information acquiring circuit that acquires information about the shape of the known still object from a database related to the on-road facility.

4. The vehicle-mounted radar device according to claim 1, wherein to decide whether the target is a known still object, the landmark pursuing circuit acquires a traveling speed of the vehicle and compares the traveling speed with the time-varying change in the relative position.

5. The vehicle-mounted radar device according to claim 1, wherein the information about the initial attachment position of the vehicle-mounted radar device is information at a time of attachment of the vehicle-mounted radar device, the information including a height from the road and an angle of the radar axis with respect to the road.

6. A method of detecting an axial deviation in a vehicle-mounted radar device, the method comprising:
transmitting a radar transmission waves from a vehicle-mounted radar device attached to a vehicle;
receiving a radar reflected waves created as a result of the radar transmission waves being reflected by a target;
detecting landmark information corresponding to the target from the radar reflected waves;
deciding whether the target is a known still object by pursuing a time-varying change in a relative position with respect to the vehicle, the relative position being included in the landmark information;
deciding, if the target is a known still object, whether a radar axis of the vehicle-mounted radar device has a deviation according to a difference between a first value and a second value, the first value being a distance between the vehicle and the still object calculated based on a shape of the known still object, the shape being obtained according to the landmark information, and information about an initial attachment position of the vehicle-mounted radar device, the second value being a second distance at a point of time when a radar reflected wave having attenuated power of the known still object among the radar reflected waves is received; and
making a notification of a deviation of the radar axis of the vehicle-mounted radar device.
